(19) United States
(12) Patent Application Publication
(10) Pub. No.: US 2024/0375657 A1
(43) Pub. Date: Nov. 14, 2024

(54) METHOD FOR OPERATING A DECELERATION SYSTEM, CONTROL DEVICE, DECELERATION SYSTEM, AND VEHICLE COMPRISING A DECELERATION SYSTEM

(71) Applicant: Continental Automotive Systems, Inc., Auburn Hills, MI (US)

(72) Inventors: Antonio Minna, JR., Sterling Heights, MI (US); Patrick Henke, Rochester Hills, MI (US)

(73) Assignee: Continental Automotive Systems, Inc., Auburn Hills, MI (US)

(21) Appl. No.: 18/315,987

(22) Filed: May 11, 2023

(51) Int. Cl. B60W 30/18; B60W 10/08; B60W 10/18; B60W 50/00

(52) U.S. Cl. CPC B60W 30/18136; B60W 10/08; B60W 10/18; B60W 50/00; B60W 2050/0026; B60W 2520/06; B60W 2530/10; B60W 2552/15; B60W 2710/08; B60W 2710/18

(57) ABSTRACT

A method for operating a deceleration system for deceleration a plurality of wheels of a vehicle, the deceleration system comprising at least one control device comprising at least one microprocessor and/or at least one microcontroller is disclosed. The method comprises determining, a total deceleration effort value to be applied by the deceleration system and a distributing the total deceleration effort value by the at least one control device, to a front deceleration effort value to be applied to front wheels of the vehicle by the deceleration system and to a rear deceleration effort value to be applied to rear wheels of the vehicle by the deceleration system. The method comprises sending, by the at least one control device, a control signal to the deceleration system, the control signal comprising the front deceleration effort value and the rear deceleration effort value.

### TECHNICAL FIELD

A system and method for operating a deceleration system and control device of a deceleration system are disclosed.

### BACKGROUND

A hill descent control feature of a vehicle is an off road cruise control feature of a braking systems of the vehicle that controls a speed of the vehicle during a descending of a hill. Common braking systems of the vehicle control the descending of the hill via brake modulation of the brakes of the vehicle. The braking system spreads a total braking amount out evenly between all four wheels of the vehicle. With high grades in either direction this can be dangerous by causing a pivot point or a direction of a normal force on the vehicle based on where the loading of the vehicle is located. Therefore, the common brake modulation may cause a tipping hazard.

Accordingly, it is an object of the present disclosure to improve the hill descent control feature of a braking system with regard to a consideration of a tipping hazard.

### SUMMARY

According to one aspect, a method for operating a deceleration system for deceleration a plurality of wheels of a vehicle is provided. The deceleration system comprises at least one control device comprising at least one microprocessor and/or at least one microcontroller. The method comprises a receiving of a deceleration signal by the at least one control device, the deceleration signal comprising a predetermined value of deceleration of the vehicle by which the vehicle is to be decelerated by the deceleration system of the vehicle. The method comprises a receiving of a sensor signal by the at least one control device, the sensor signal comprising at least a current value of a longitudinal tilt or pitch of the vehicle in a driving direction of the vehicle. The method comprises a step of, based on the predetermined value of deceleration and on the current value of the longitudinal tilt, determining, by the at least one control device, a total deceleration effort value to be applied by the deceleration system to the plurality of wheels to decelerate the vehicle by the value of deceleration. In a further step, at least on the basis of the current value of the longitudinal tilt of the vehicle in the driving direction, distributing or splitting the total deceleration effort by the at least one control device, to a front deceleration effort value to be applied to front wheels of the vehicle by the deceleration system and to a rear deceleration effort value to be applied to rear wheels of the vehicle by the deceleration system. A further step comprises a sending by the at least one control device, a control signal to the deceleration system, the control signal comprising the front deceleration effort value and the rear deceleration effort value. The method comprises an applying by the at least one front deceleration unit of the deceleration system, the front deceleration effort value to the front wheels and applying, by at least one rear deceleration unit of the deceleration system, the rear deceleration effort value to the rear wheels.

A control device, comprising at least one microprocessor and/or at least one microcontroller is also provided. The control device is configured to receive a deceleration signal, the deceleration signal comprising a predetermined value of deceleration of a vehicle by which the vehicle is to be decelerated by a deceleration system of the vehicle. The control device is configured to receive a sensor signal, the sensor signal comprising at least a current value of a longitudinal tilt of the vehicle in the driving direction of the vehicle. The control device is configured to, based on the predetermined value of deceleration and on the current value of the longitudinal tilt, determine, a total deceleration effort value to be applied by the deceleration system to a plurality of wheels to decelerate the vehicle by the value of deceleration. The control device is configured to, at least on the basis of the current value of the longitudinal tilt of the vehicle in the driving direction, distribute the total deceleration effort value to a front deceleration effort value to be applied to front wheels of the vehicle by the deceleration system and to a rear deceleration effort value to be applied to rear wheels of the vehicle by the deceleration system. The control device is configured to send a control signal to the deceleration system, the control signal comprising the front deceleration effort value and the rear deceleration effort value.

A deceleration system is also provided. The deceleration system comprises at least one control device comprising at least one microprocessor and/or at least one microcontroller. The control device is configured to receive a deceleration signal, the deceleration signal comprising a predetermined value of deceleration of a vehicle by which the vehicle is to be decelerated by a deceleration system of the vehicle. The control device is configured to receive a sensor signal, the sensor signal comprising at least a current value of a longitudinal tilt of the vehicle in the driving direction of the vehicle. The control device is configured to, based on the predetermined value of deceleration and on the current value of the longitudinal tilt, determine, a total deceleration effort value to be applied by the deceleration system to a plurality of wheels to decelerate the vehicle by the value of deceleration. The control device is configured to, at least on the basis of the current value of the longitudinal tilt of the vehicle in the driving direction, distribute the total deceleration effort value to a front deceleration effort value to be applied to front wheels of the vehicle by the deceleration system and to a rear deceleration effort value to be applied to rear wheels of the vehicle by the deceleration system. The control device is configured to send a control signal to the deceleration system, the control signal comprising the front deceleration effort value and the rear deceleration effort value.

The disclosure also comprises the combinations of the features of the described embodiments.

### BRIEF DESCRIPTION OF THE DRAWINGS

The present disclosure will become more fully understood from the detailed description and the accompanying drawings, wherein:

FIG. 1 is a schematic illustration of an embodiment of a vehicle; and

FIG. 2 is a schematic illustration of a method for operating a deceleration system.

### DETAILED DESCRIPTION

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

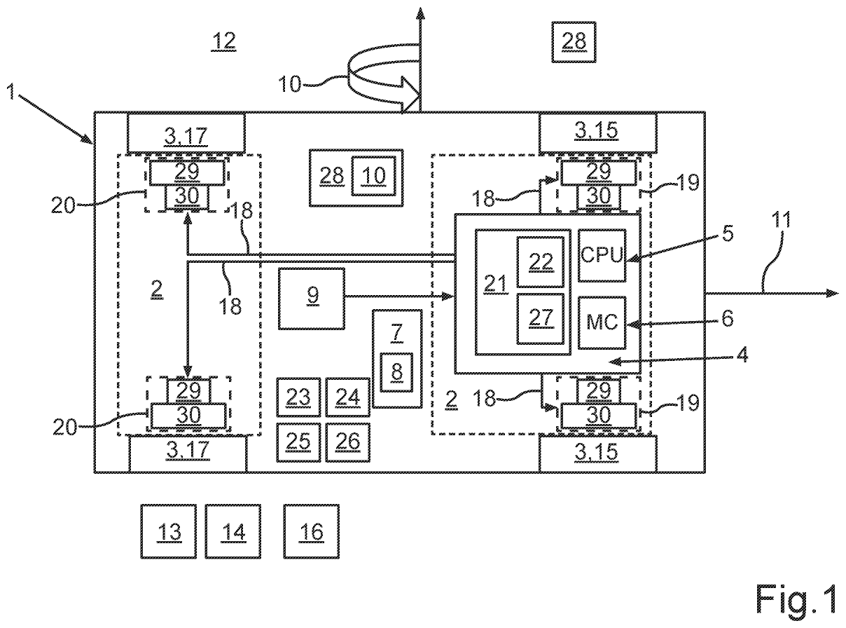

FIG. 1 shows a schematic illustration of a vehicle 1. The vehicle 1 may be an automobile, for example a passenger car or truck. The vehicle 1 may comprise a deceleration system 2 comprising deceleration units 19, 20 configured to brake the wheels 3, 15, 17 of the vehicle 1. The respective deceleration units may comprise a braking unit 29. The braking units 29 may be configured to brake the wheels 3, 15, 17 by absorbing mechanical energy. The braking units 29 may be configured to decelerate or brake the wheels 3, 15, 17 by converting mechanical energy of the respective wheel 3, 15, 17 and/or the respective axle into heat. The braking units 29 may be configured as disc brakes, configured to brake the respective wheel by pressing pads of the disc brake to a disc of the disc brake. The braking units 29 may be configured as drum brakes, configured to brake the respective wheel 3, 15, 17 by pressing shoes of the braking unit 29 to an inner surface of drum pads of the drum brake. However the kind of the braking units 29 is not limited to these two types. The deceleration units 19, 20 of the deceleration system 2 may comprise an electric motor unit 30 of a powertrain of the vehicle 1. The electric motor units 30 may be configured to drive the respective wheel 3, 15, 17 and/or the respective axle. The electric motor units 30 may be configured to decelerate or brake the wheels 3, 15, 17 or the axles by converting mechanical energy of the respective wheel and/or the respective axle into electric energy.

The deceleration system 2 may comprise a control device 4 comprising a microprocessor 5 and/or a microcontroller 6.

The vehicle 1 may comprise a hill descent control system 9 configured to control a speed of the vehicle 1 when the vehicle 1 drives down a slope on an underground 12 under the vehicle 1. The vehicle 1 may drive in a driving direction 11 wherein a current value of a longitudinal tilt 10 of the vehicle 1 may be observed by the hill descent control system 9 in order to send a deceleration signal 7 to the control device 4 of the deceleration system 2. The deceleration signal 7 may comprise a predetermined value of deceleration 8 to be provided by the deceleration system 2 to control the speed of the vehicle 1.

To decelerate the vehicle 1 by the predetermined value of the deceleration, the control device 4 of the deceleration system 2 may be configured to evaluate a total deceleration effort value 13 to be provided by the wheels 3 of the vehicle 1 in total. The control device 4 may be configured to evaluate the total deceleration effort value 13 based on a look-up table, a program 27 (comprising programming instructions) or a predefined method, stored in the control device 4.

The control device 4 may be configured to distribute the total deceleration effort value 13 to a front deceleration effort value 14 and a rear deceleration effort value 16. The front deceleration effort value 14 may define a deceleration of the vehicle 1 to be provided by front wheels 3, 15 of the vehicle 1. The rear deceleration effort value 16 describes the deceleration effort value to be provided by the rear wheels 3, 17 of the vehicle 1. The distribution of the total deceleration effort value 13 to the front deceleration effort value 14 and the rear deceleration effort value 16 may be performed by the control device 4 according to a predefined program 27 and/or a look-up table stored in the control device 4.

To provide the front deceleration effort value 14 and the rear deceleration effort value 16 by the front wheels 3, 15 and the rear wheels 3, 17, the control device 4 may be configured to send a control signal 18 to front deceleration units 19 of the deceleration system 2 which may configured to brake the front wheels 3 of the vehicle 1. The control device 4 may be configured to send the control signal 18 to the rear deceleration units 20 of the deceleration system 2 which may be configured to brake the rear wheels 3 of the vehicle 1. The control device 4 may comprise a data storage or memory device 21 configured to store the look-up tables, programs 27 and orders to perform a method to operate the deceleration system 2. The distribution of the total deceleration effort value 13 to the front deceleration effort value 14 and the rear deceleration effort value 16 may be performed depending on a pivot point 23 of the vehicle 1. The distribution may also depend on a loading 24 of the vehicle 1, a loading distribution 25 of the vehicle 1 or a torque 26 of the vehicle 1. The loading 24 of the vehicle 1, the loading distribution 25 or the torque 26 may be provided to the control device 4 via the sensor signal 28.

The deceleration may be performed by the braking units 29 of the deceleration units 20 and/or the electric motor units 30 of the deceleration units 20.

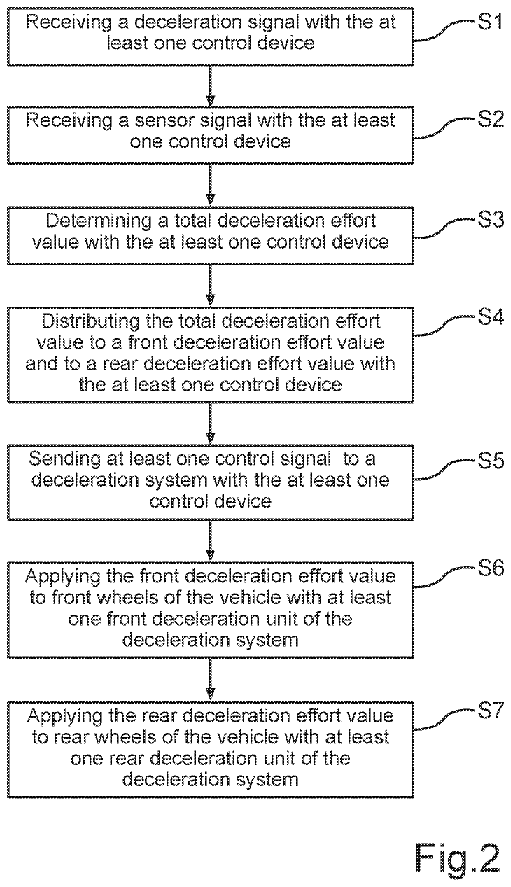

FIG. 2 shows a schematic illustration of a method for operating a deceleration system 2.

In a first step S1, the at least one control device 4 of the deceleration system 2 may receive a deceleration signal 7. The deceleration signal 7 may comprise a predetermined value of the deceleration of the vehicle 1, by which the vehicle 1 is to be decelerated by the deceleration system 2 of the vehicle 1.

In a second step S2, the at least one control device 4 may receive a sensor signal 28. The sensor signal 28 may comprise at least a current value of a longitudinal tilt of the vehicle 10 in the driving direction 11 of the vehicle 1.

In a third step S3, the at least one control device 4 may determine a total deceleration effort value 13 to be applied by the deceleration system 2 to the plurality of wheels 3 to decelerate the vehicle 1 by the value of deceleration. The determination of the total deceleration effort value 13 may be based on the predetermined value of deceleration 8 and on the current value of the longitudinal tilt.

In a fourth step S4, the control device 4 may distribute the total deceleration effort value 13 to a front deceleration effort value 14 to be applied to front wheels 3 of the vehicle 1 by the deceleration system 2 and to a rear deceleration effort value 16 to be applied to rear wheels 3 of the vehicle 1 by the deceleration system 2. The control device 4 may distribute the total deceleration effort value 13 at least one the basis of the current value of the longitudinal tilt of the vehicle 1 in the driving direction 11.

In a fifth step S5, the at least one control device 4 may send the at least one control signal 18 to the deceleration system 2, wherein the control signal 18 may comprise the front deceleration effort value 14 and the rear deceleration effort value 16.

In a sixth step S6, at least one front deceleration unit of the deceleration system 2 may apply the front deceleration effort value 14 to the front wheels 3 of the vehicle 1.

In a seventh step S7, at least one rear deceleration unit of the deceleration system 2 may provide the rear deceleration effort value 16 to the rear wheels 3 of the vehicle 1.

The distributing the total deceleration effort value 13 by the at least one control device 4 may be performed on a basis of a look up table 22, stored in the control device 4, the look up table 22 comprising predefined distributions of the total deceleration effort value 13 to the front deceleration effort value 14 and to the rear deceleration effort value 16 at least on the basis of the current value of the longitudinal tilt of the vehicle 1.

The distribution of the total deceleration effort value 13 by the at least one control device 4 may be performed on a basis of a pivot point 23 of the vehicle 1, provided to the at least one control device 4 via the sensor signal 28.

The distribution of the total deceleration effort value 13 by the at least one control device 4 may be performed on a basis of a loading 24 of the vehicle 1, provided to the at least one control device 4 via the sensor signal 28.

The distribution of the total deceleration effort value 13 by the at least one control device 4 may be performed on a basis of a loading distribution 25 of the vehicle 1, provided to the at least one control device 4 via the sensor signal 28.

The distribution of the total deceleration effort value 13 by the at least one control device 4 may be performed on a basis of a torque 26 of the vehicle 1, provided to the at least one control device 4 via the sensor signal 28.

For use cases or use situations which may arise in the method and which are not explicitly described here, it may be provided that, in accordance with the method, an error message and/or a prompt for user feedback is output and/or a default settings and/or a predetermined initial state is set.

Overall, the example shows how an improvement of a hill descent control feature of a deceleration system 2 with regard to a consideration of a tipping hazard is provided.

The foregoing description shall be interpreted as illustrative and not be limited thereto. One of ordinary skill in the art would understand that certain modifications may come within the scope of this disclosure. Although the different non-limiting embodiments are illustrated as having specific components or steps, the embodiments of this disclosure are not limited to those combinations. Some of the components or features from any of the non-limiting embodiments may be used in combination with features or components from any of the other non-limiting embodiments. For these reasons, the appended claims should be studied to determine the true scope and content of this disclosure.

1. A method for operating a deceleration system for decelerating a plurality of wheels of a vehicle comprising:
receiving a deceleration signal by an at least one control device, the deceleration signal comprising a predetermined value of deceleration of the vehicle by which the vehicle is to be decelerated by the deceleration system of the vehicle;
receiving a sensor signal by the at least one control device, the sensor signal comprising at least a current value of a longitudinal tilt of the vehicle in a driving direction of the vehicle;
based on the predetermined value of deceleration and on the current value of the longitudinal tilt, determining, by the at least one control device, a total deceleration effort value to be applied by the deceleration system to the plurality of wheels to decelerate the vehicle by the value of deceleration;
at least on the basis of the current value of the longitudinal tilt of the vehicle in the driving direction, distributing the total deceleration effort value by the at least one control device, to a front deceleration effort value to be applied to front wheels of the vehicle by the deceleration system and to a rear deceleration effort value to be applied to rear wheels of the vehicle by the deceleration system;
sending, by the at least one control device, a control signal to the deceleration system, the control signal comprising the front deceleration effort value and the rear deceleration effort value;
applying, by at least one front deceleration unit of the deceleration system, the front deceleration effort value to the front wheels; and
applying, by at least one rear deceleration unit of the deceleration system, the rear deceleration effort value to the rear wheels.

2. The method according to claim 1, wherein the distributing of the total deceleration effort value by the at least one control device is performed on the basis of a look up table, stored in the control device, the look up table comprising predefined distributions of the total deceleration effort value to the front deceleration effort value and to the rear deceleration effort value at least on the basis of the current value of the longitudinal tilt of the vehicle.

3. The method according to claim 1, wherein the distributing of the total deceleration effort value by the at least one control device is performed on the basis of a pivot point of the vehicle.

4. The method according to claim 1, wherein the distributing of the total deceleration effort value by the at least one control device is performed on the basis of a loading of the vehicle.

5. The method according to claim 1, wherein the distributing of the total deceleration effort value by the at least one control device is performed on the basis of a loading distribution of the vehicle.

6. The method according to claim 1, wherein the distributing of the total deceleration effort value by the at least one control device is performed on the basis of a torque of the vehicle.

7. The method according to claim 1, wherein at least one of the deceleration units of the deceleration system comprises a braking unit.

8. The method according to claim 1, wherein at least one of the deceleration units of the deceleration system comprises an electric motor unit of a powertrain of the vehicle.

9. A control device comprising at least one of amicroprocessor and at least one microcontroller, wherein the control device is configured to:
receive a deceleration signal, the deceleration signal comprising a predetermined value of deceleration of a vehicle by which the vehicle is to be decelerated by a deceleration system of the vehicle;
receive a sensor signal, the sensor signal comprising at least a current value of a longitudinal tilt of the vehicle in a driving direction of the vehicle;
based on the predetermined value of deceleration and on the current value of the longitudinal tilt, determine, a total deceleration effort value to be applied by the deceleration system to a plurality of wheels to decelerate the vehicle by the value of deceleration;
at least on the basis of the current value of the longitudinal tilt of the vehicle in the driving direction, distribute the total deceleration effort value to a front deceleration effort value to be applied to front wheels of the vehicle by the deceleration system and to a rear deceleration effort value to be applied to rear wheels of the vehicle by the deceleration system; and
send a control signal to the deceleration system; the control signal comprising the front deceleration effort value and the rear deceleration effort value.

10. A deceleration system for deceleration a plurality of wheels of a vehicle, the deceleration system comprising at least one control device comprising at least one of a microprocessor and at least one microcontroller wherein the control device is configured to:
receive a deceleration signal, the deceleration signal comprising a predetermined value of deceleration of a vehicle by which the vehicle is to be decelerated by a deceleration system of the vehicle;
receive a sensor signal, the sensor signal comprising at least a current value of a longitudinal tilt of the vehicle in a driving direction of the vehicle;
based on the predetermined value of deceleration and on the current value of the longitudinal tilt, determine, a total deceleration effort value to be applied by the deceleration system to a plurality of wheels to decelerate the vehicle by the value of deceleration;
at least on the basis of the current value of the longitudinal tilt of the vehicle in the driving direction, distribute the total deceleration effort value to a front deceleration effort value to be applied to front wheels of the vehicle by the deceleration system and to a rear deceleration effort value to be applied to rear wheels of the vehicle by the deceleration system;
send a control signal to the deceleration system; the control signal comprising the front deceleration effort value and the rear deceleration effort value;
the deceleration system comprising at least one front deceleration unit configured to apply the front deceleration effort value to the front wheels; and
the deceleration system comprising at least one rear deceleration unit configured to apply the rear deceleration effort value to the rear wheels.
